(19) United States
(12) Patent Application Publication
(10) Pub. No.: US 2023/0223568 A1
(43) Pub. Date: Jul. 13, 2023

(54) ANODE SUB-SYSTEM FOR A FUEL CELL SYSTEM, AND FUEL CELL SYSTEM

(71) Applicant: Robert Bosch GmbH, Stuttgart (DE)

(72) Inventors: Benedikt Leibssle, Stuttgart (DE); Dirk Schnittger, Ludwigsburg (DE)

(21) Appl. No.: 18/015,826

(22) PCT Filed: Jun. 17, 2021
(86) PCT No.: PCT/EP2021/066474

§ 371 Date: Jan. 12, 2023

(30) Foreign Application Priority Data
Jul. 15, 2020 (DE) 10 2020 208 834.9

(51) Int. Cl. H01M 8/04119; H01M 8/04089

(52) U.S. Cl. CPC H01M 8/04164; H01M 8/04097

(57) ABSTRACT

The invention relates to an anode sub-system (1) for a fuel cell system with at least one fuel cell (2), comprising a supply path (3) for supplying the fuel cell (2) with hydrogen and comprising a recirculation path (4) for recirculating a gas mixture which exits the fuel cell (2) and contains water and hydrogen, wherein a water separator (5) is arranged in the recirculation path (4), and the recirculation path (4) is connected to the supply path (3) downstream of the water separator (5) via a jet pump (7). According to the invention, the supply path (3) is connected to the water separator (5) at the deepest point of the supply path via a connection line (9). The invention additionally relates to a fuel cell system comprising such an anode sub-system (1).

### BACKGROUND

The invention relates to an anode sub-system for a fuel cell system having at least one fuel cell. In addition, the invention relates to a fuel cell system having at least one fuel cell and an anode sub-system according to the invention for supplying the fuel cell with hydrogen.

Hydrogen-based fuel cell systems are considered the mobility concept of the future since they substantially only emit water and enable rapid refueling times. The hydrogen is stored in a tank which is carried on board a vehicle. The oxygen, which is also required, is taken from the ambient air. Hydrogen and oxygen react in a fuel cell to form water or water vapor. At the same time, electrical power is generated by electrochemical conversion.

The hydrogen is generally supplied to an anode of at least one fuel cell in a fuel cell system via an anode sub-system. The latter comprises a supply path, via which hydrogen is supplied to the at least one fuel cell, and a recirculation path, via which hydrogen leaving the fuel cell is recirculated. Since it is usually a gas mixture, which may also contain liquid water, that escapes from the fuel cell rather than pure hydrogen, a water separator via which liquid water is separated is usually integrated into the recirculation path. Since the gas mixture can, in particular, contain nitrogen in addition to hydrogen, the recirculation path is also rinsed regularly. For this purpose, a purge valve, via which the gas mixture can escape, is opened. The remaining gas volume is fed into the supply path again.

In an anode sub-system of the aforementioned type, water can also accumulate outside the water separator during operation and/or in the event of the fuel cell system being shut down. This accumulation of water can lead to problems. In the event of a shutdown, for example, it can cause problems when the system is being restarted. Furthermore, the accumulation of water can impair the function of components, such as sensors. At low outside temperatures, the water can also freeze and lead to damage caused by ice pressure.

The object of the present invention is therefore to prevent or at least reduce the undesirable accumulation of water in an anode sub-system for a fuel cell system.

The invention is not limited to mobile fuel cell systems but can also be applied to stationary fuel cell systems.

### SUMMARY

An anode sub-system for a fuel cell system having at least one fuel cell is proposed, which comprises a supply path for supplying the fuel cell with hydrogen and a recirculation path for recirculating a gas mixture leaving the fuel cell and containing water and hydrogen. A water separator is arranged in the recirculation path and the recirculation path is connected to the supply path downstream of the water separator via a jet pump. According to the invention, the supply path is connected to the water separator at the lowest point of the supply path via a connection line.

The proposed anode sub-system is accordingly designed such that water located in the supply path collects at the lowest point and can be supplied to the water separator via the proposed connection line. The water can then be removed from the anode sub-system via the water separator so that it is no longer able to freeze and cause damage due to ice pressure. At the “lowest point” means at the geodetically lowest point at which the water collects due to gravity when the jet pump is switched off. In order to enable optimal use of gravity, it is furthermore proposed that the connection line, starting from the lowest point of the supply path, has a gradient to the water separator. However, the gradient is not absolutely necessary since, during operation of the jet pump, the pressure in the supply path is generally higher than the pressure in the recirculation path so that water is already expelled from the supply path into the water separator via the existing pressure gradient.

Furthermore, it is proposed that the water separator for collecting the separated water comprises a water tank or is connected to a water tank. In this case, the collected water can be supplied for further use, for example for wetting a reaction gas of the fuel cell system.

According to a preferred embodiment of the invention, the jet pump has a first connection for the recirculation path and a second connection for the supply path, wherein the first connection is located above the second connection. This means that the jet pump is flowed through from top to bottom. This ensures that no water can accumulate inside the jet pump.

The jet pump further preferably comprises a third connection for connecting to a hydrogen feed path. The recirculation stream thus mixes with fresh hydrogen inside the jet pump. The third connection for the hydrogen feed path is preferably arranged above the first connection for the recirculation path. In this case, the recirculation stream is entrained by the feed stream. For this purpose, the first connection is preferably arranged at the side.

For optimal use of gravity, it is furthermore proposed that, in the installed state, the water separator is arranged at the lowest point or at the geodetically lowest point of the anode sub-system. In this way, water can be discharged from both the supply path and the recirculation path in the direction of the water separator due to gravity. This means that the supply path and the recirculation path each come to rest completely above the water separator, so that water present in these paths flows in the direction of the water separator due to or with the aid of gravity. The accumulation of water and the associated problems are thus avoided.

A throttle is preferably integrated into the connection line, which leads from the lowest point of the supply path to the water separator. The throttle enables the parasitic currents back into the water separator to be adjusted and thus reduced. This can increase the efficiency of the system.

Alternatively or additionally, it is proposed that a valve be integrated into the connection line. The valve also enables the parasitic currents back into the water separator to be adjusted and thus reduced. This can therefore further increase the efficiency of the system. This applies in particular if, according to a preferred embodiment, the valve is designed as a passive valve. For example, the passive valve can be designed such that it closes against the spring force of a spring when the jet pump is in conveying mode. In the rest position, that is to say when the jet pump is shut down, the valve is held open by the spring. Water present in the supply path can thus run off freely in the direction of the water separator.

A fan is advantageously arranged in the recirculation path, preferably between the water separator and the jet pump. The fan supports recirculation in the recirculation path.

Furthermore, it is proposed that the water separator, preferably the water tank of the water separator, is connected to a gas line with an integrated purge valve and/or to a water line with an integrated drain valve. The recirculation path can then be flushed via the gas line with integrated purge valve in order, for example, to reduce the nitrogen oxide concentration. The water tank of the water separator can be emptied via the water line with integrated drain valve.

The fuel cell system proposed in addition for achieving the aforementioned object is characterized in that it comprises at least one fuel cell and an anode sub-system according to the invention for supplying the fuel cell with hydrogen. The advantages of the anode sub-system according to the invention also extend to the fuel cell system according to the invention.

### BRIEF DESCRIPTION OF THE DRAWINGS

Preferred embodiments of the invention are explained in more detail below with reference to the accompanying drawings. The drawings show:

FIG. 1 a schematic section through a first anode sub-system according to the invention,

FIG. 2 a schematic section through a second anode sub-system according to the invention,

FIG. 3 an enlarged detail of FIG. 2,

FIG. 4 a schematic section through a third anode sub-system according to the invention during operation of a jet pump,

FIG. 5 an enlarged detail of FIG. 4,

FIG. 6 a schematic section through the anode sub-system of FIG. 4, but with the jet pump shut down, and

FIG. 7 an enlarged detail of FIG. 6.

### DETAILED DESCRIPTION

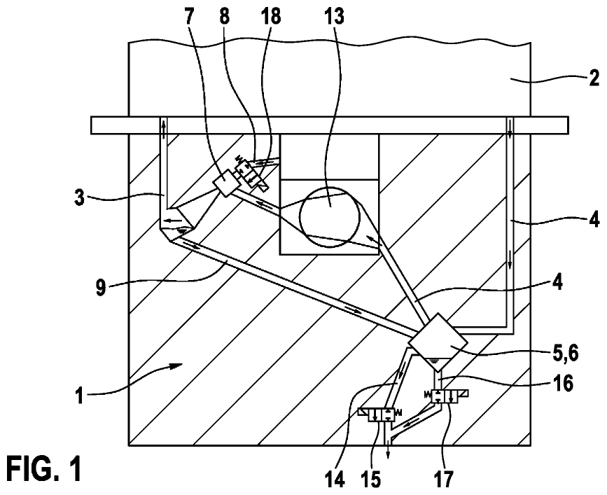

The anode sub-system 1 according to the invention shown in FIG. 1 serves to supply at least one fuel cell 2 of a fuel cell system with hydrogen. For this purpose, it comprises a supply path 3, which is connected via a jet pump 7 to a hydrogen feed path 8 and to a recirculation path 4. The supply path 3 can thus be supplied with fresh hydrogen via the hydrogen feed path 8 and with hydrogen recirculated via the recirculation path 4. The volume of fresh hydrogen can be controlled via a hydrogen valve 18 integrated into the hydrogen feed path 8.

A water separator 5 comprising a water tank 6 is integrated into the recirculation path 4. The water tank 6 can be emptied via a water line 16, which is introduced from below, with an integrated drain valve 17. A nitrogen-containing gas mixture can be discharged from the recirculation path 4, or the recirculation path 4 can be flushed, via a gas line 14, which is introduced at the side of the water tank 6, with an integrated purge valve 15. This is necessary from time to time since nitrogen as well as liquid water escape from the fuel cell 2 with the hydrogen when the fuel cell system is in operation. The liquid water is separated via the water separator 5 and collected in the water tank 6; the nitrogen is removed via the flush volume.

A fan 13, by means of which the hydrogen leaving the fuel cell 2 can be optimally recirculated, is also integrated into the recirculation path 4.

Since, in principle, water can accumulate or precipitate at any point in the anode sub-system 1 so that undesirable water accumulation can form, the anode sub-system 1 shown in FIG. 1 comprises at its geodetically lowest point the water separator 5 with the water tank 6. The latter is connected to the supply path 3, specifically at the lowest point thereof, via a steadily rising connection line 9. It is thereby ensured that water accumulating or precipitating in the supply path 3 runs into the water tank 6 due to gravity even when the jet pump 7 is shut down. Undesirable accumulation of water is thus avoided.

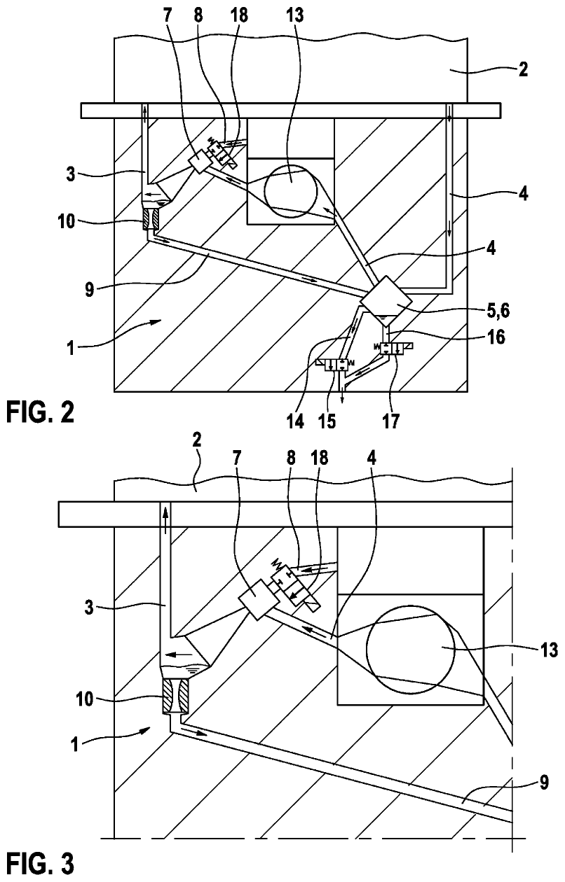

FIGS. 2 and 3 show a development of the anode sub-system 1 of FIG. 1. In contrast to FIG. 1, a throttle 10 is integrated into the connection line 9. The throttle 10 leads to a controlled draining of water, which accumulates or precipitates in the jet pump 7 or in the supply path 3 downstream of the jet pump 7. In this way, parasitic currents are reduced, in particular during operation of the jet pump 7. As a result, the efficiency of the system is thus increased.

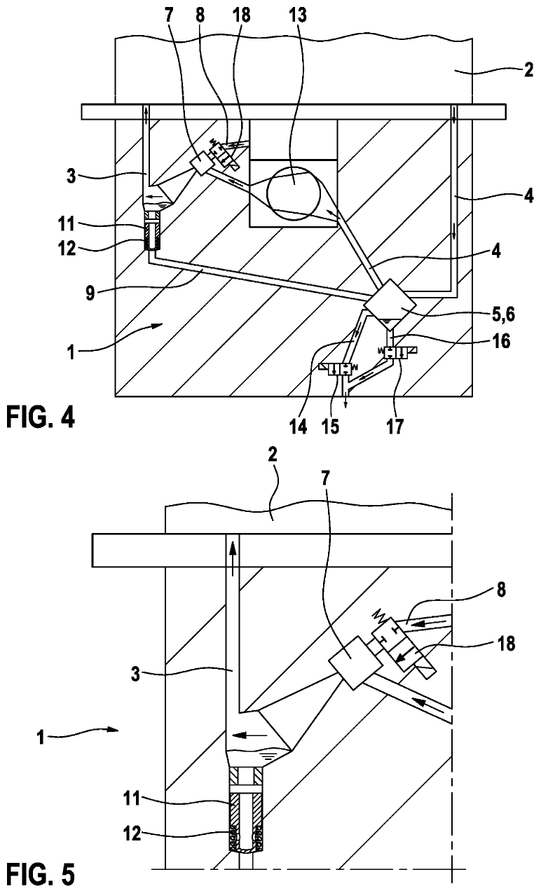

FIGS. 4 and 7 show a further embodiment of an anode sub-system 1 according to the invention. Instead of a throttle 10 according to the embodiment shown in FIGS. 2 and 3, a passive valve 11 is integrated into the connection line 9 here. Opening and closing of the valve 11 is pressure-controlled.

During operation of the jet pump 7 (FIGS. 4 and 5), the pressure in the supply path 3 increases so that a pressure gradient, which closes the valve 11 against the spring force of a spring 12, prevails between the supply path 3 and the recirculation path 4. Parasitic streams in the direction of the water separator 5 or the water tank 6 are thus completely prevented so that the efficiency of the system is increased further.

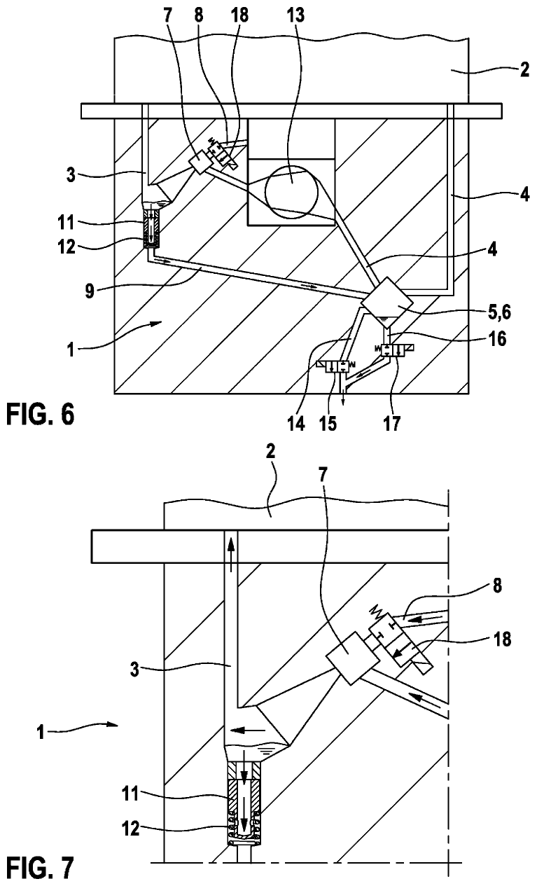

When the jet pump 7 is shut down (FIGS. 6 and 7), there is no pressure gradient keeping the valve 11 closed, so that the spring 12 opens the valve 11 and water present in the supply path 3 can flow out into the water tank 6 due to gravity.

1. An anode sub-system (1) for a fuel cell system having at least one fuel cell (2), comprising a supply path (3) for supplying the at least one fuel cell (2) with hydrogen and a recirculation path (4) for recirculating a gas mixture which exits the at least one fuel cell (2) and contains water and hydrogen, wherein a water separator (5) is arranged in the recirculation path (4), and wherein the recirculation path (4) is connected to the supply path (3) downstream of the water separator (5) via a jet pump (7), wherein the supply path (3) is connected to the water separator (5) at the lowest point of the supply path via a connection line (9).

2. The anode sub-system (1) according to claim 1, wherein the water separator (5) for collecting separated water comprises a water tank (6) or is connected to a water tank (6).

3. The anode sub-system (1) according to claim 1, wherein the jet pump (7) has a first connection for the recirculation path (4) and a second connection for the supply path (3), and wherein the first connection is located above the second connection.

4. The anode sub-system (1) according to claim 3, wherein the jet pump (7) has a third connection for connecting to a hydrogen feed path (8).

5. The anode sub-system (1) according to claim 1, wherein, in the installed state of the anode sub-system (1), the water separator (5) is arranged at a lowest point so that water present in the supply path (3) and/or in the recirculation path (4) can be discharged via the water separator (5) due to gravity.

6. The anode sub-system (1) according to claim 1, wherein a throttle (10) is integrated into the connection line (9).

7. The anode sub-system (1) according to claim 1, wherein a valve (11) is integrated into the connection line (9).

8. The anode sub-system (1) according to claim 1, wherein a fan (13) is arranged in the recirculation path (4).

9. The anode sub-system (1) according to one claim 1, wherein the water separator (5), preferably the water tank (6) of the water separator (5), is connected to a gas line (14) with an integrated purge valve (15) and/or to a water line (16) with an integrated drain valve (17).

10. A fuel cell system having at least one fuel cell (2) and an anode sub-system (1) according to claim 1 for supplying hydrogen to the at least one fuel cell (2).

11. The anode sub-system (1) according to claim 4, wherein the hydrogen feed path (8) is arranged above the first connection for the recirculation path (4).

12. The anode sub-system (1) according to claim 7, wherein the valve (11) is a passive valve.

13. The anode sub-system (1) according to claim 8, wherein the valve (11) closes against a spring force of a spring (12) when the jet pump (7) is in a conveying mode.

14. The anode sub-system (1) according to claim 8, wherein the fan (13) is arranged between the water separator (5) and the jet pump (7).

15. The anode sub-system (1) according to claim 9, wherein the water tank (6) of the water separator (5) is connected to the gas line (14) with an integrated purge valve (15) and/or to the water line (16) with an integrated drain valve (17).
